(19) United States
(12) Patent Application Publication
(10) Pub. No.: US 2015/0154022 A1
(43) Pub. Date: Jun. 4, 2015

(54) Soft-Partitioning of a Register File Cache

(71) Applicant: Imagination Technologies Limited, Kings Langley (GB)

(72) Inventors: Anand Khot, Watford (GB); Hugh Jackson, Sydney (AU)

(21) Appl. No.: 14/548,041

(22) Filed: Nov. 19, 2014

(30) Foreign Application Priority Data
Nov. 29, 2013 (GB) 1321077.8

(51) Int. Cl. G06F 9/30

(52) U.S. Cl. CPC G06F 9/30098; G06F 9/30145

(57) ABSTRACT

Soft-partitioning of a register file cache is implemented by renaming registers associated with an instruction based on which thread, in a multi-threaded out-of-order processor, the instruction belongs to. The register renaming may be performed by a register renaming module and in an embodiment, the register renaming module receives an instruction for register renaming which identifies the thread associated with the instruction and one or more architectural registers. Available physical registers are then allocated to each identified architectural register based on the identified thread. In some examples, the physical registers in the multi-threaded out-of order processor are logically divided into groups and physical registers are allocated based on a thread to group mapping. In further examples, the thread to group mapping is not fixed but may be updated based on the activity level of one or more threads in the multi-threaded out-of-order processor.

### BACKGROUND

Many modern processors are multi-threaded and each thread is able to execute simultaneously on the same processor core. In a multithreaded processor, some of the resources within the core are replicated (such that there is an instance of the resource for each thread) and some of the resources are shared between threads. Where resources are shared between threads, performance bottlenecks can occur where the operation of one thread interferes with that of the other threads. For example, where cache resources are shared between threads, conflicts can occur when one thread fills the cache with data. As data is added to an already full cache, data which may be being used by other threads (called ‘victim’ threads) may be evicted (to provide space for the new data). The evicted data will then need to be fetched again when it is next required and this impacts the performance of the victim thread that requires the data. A solution to this is to provide a separate cache for each thread.

The embodiments described below are not limited to implementations which solve any or all of the disadvantages of known multi-threaded processors.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Soft-partitioning of a register file cache is described. This soft-partitioning is implemented by renaming a destination register associated with an instruction based on which thread, in a multi-threaded out-of-order processor, the instruction belongs to. The register renaming may be performed by a register renaming module and in an embodiment, the register renaming module receives an instruction for register renaming which identifies the thread associated with the instruction and one or more architectural registers. Available physical registers are then allocated to each identified architectural register based on the identified thread. In some examples, the physical registers in the multi-threaded out-of order processor are logically divided into groups and physical registers are allocated based on a thread to group mapping. In further examples, the thread to group mapping is not fixed but may be updated based on the activity level of one or more threads in the multi-threaded out-of-order processor.

A first aspect provides a method of using register renaming to dynamically allocate a resource, in addition to physical registers, between threads in a multi-threaded out-of-order processor comprising a plurality of physical registers, the method comprising: receiving an instruction for register renaming, the instruction identifying an architectural register and a thread associated with the instruction; allocating an available physical register from the a plurality of physical registers in the processor to the architectural register based at least on the thread associated with the instruction, wherein each of the plurality of physical registers is mapped to one or more storage locations in the dynamically allocated resource; and storing details of the register allocation.

A second aspect provides a module in a multi-threaded out-of-order processor arranged to use register renaming to dynamically allocate a resource, in addition to physical registers, between threads in the processor, the multi-threaded out-of-order processor comprising a plurality of physical registers and the module comprising hardware logic arranged to: allocate an available physical register from the a plurality of physical registers in the processor to an architectural register in an instruction based at least on a thread associated with the instruction, wherein each of the plurality of physical registers is mapped to one or more storage locations in the dynamically allocated resource.

Further aspects provide a method substantially as described with reference to FIG. 2 or 4 of the drawings, a processor substantially as described with reference to FIG. 1 or 3 of the drawings, a computer readable storage medium having encoded thereon computer readable program code for generating a processor comprising the module described herein, and a computer readable storage medium having encoded thereon computer readable program code for generating a processor configured to perform the methods described herein.

The methods described herein may be performed by a computer configured with software in machine readable form stored on a tangible storage medium e.g. in the form of a computer program comprising computer readable program code for configuring a computer to perform the constituent portions of described methods or in the form of a computer program comprising computer program code means adapted to perform all the steps of any of the methods described herein when the program is run on a computer and where the computer program may be embodied on a computer readable storage medium. Examples of tangible (or non-transitory) storage media include disks, thumb drives, memory cards etc and do not include propagated signals. The software can be suitable for execution on a parallel processor or a serial processor such that the method steps may be carried out in any suitable order, or simultaneously.

The hardware components described herein may be generated by a non-transitory computer readable storage medium having encoded thereon computer readable program code.

This acknowledges that firmware and software can be separately used and valuable. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of an example multi-threaded out-of-order processor;

FIG. 2 shows flow diagrams of example methods of physical register allocation;

FIG. 3 is a schematic diagram of another example multi-threaded out-of-order processor;

FIG. 4 shows flow diagrams of further example methods of physical register allocation; and

FIG. 5 shows a flow diagram of another example allocation method in the method of physical register allocation shown in FIG. 4.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

As described above, conflicts can occur where multiple threads within a processor (or processor core) share resources, such as a cache. One example of a cache which may be shared between threads running on a processor (or processor core) is a register file cache (RFC). An RFC is a small cache (e.g. 32 entries in size) which is used to store recently written registers to minimize the latency in accessing these registers by subsequent instructions. These recently written registers are the registers which are most likely to be read by a subsequent instruction. Without the RFC, registers need to be accessed from a larger register file (RF). Fetching registers from the RF (which may, for example, have 128 entries) has a higher latency than accessing the RFC (e.g. 2 cycles rather than 1 cycle); however, the RFC is much smaller than the RF. When the RFC is full, a new entry evicts an old entry from the RFC and there are a number of different policies which may be used to determine which entry is evicted (e.g. Least Recently Used or Least Recently Inserted).

If a requested register is found in the RFC, this is a cache hit, and the register value can be returned immediately. If, however, a requested register is not found in the RFC (a cache miss), it is fetched from the RF and causes the requesting instructions to be squashed and re-issued, which incurs a performance penalty (e.g. of 4 or more cycles). If the RFC has a high hit rate (i.e. the proportion of requested registers which result in a cache hit is high e.g. 95% +), the number of squashed instructions is reduced and the performance of the processor is improved.

Out-of-order processors can provide improved computational performance by executing instructions in a sequence that is different from the order in the program, so that instructions are executed when their input data is available rather than waiting for the preceding instruction in the program to execute. However, the flow of instructions in a program can sometimes change during execution, e.g. due to a branch or jump instruction. In such cases, a branch predictor is often used to predict which instruction branch will be taken, to allow the instructions in the predicted branch to be speculatively fetched and executed out-of-order. This means that branch mispredictions can occur. Other speculation techniques, such as pre-fetching of data, may also be used in out-of-order processors to improve performance.

A misspeculating thread (e.g. a thread which makes an incorrect branch prediction or pre-fetches data inappropriately) does not perform any useful work (e.g. because all instructions executed following the misspeculation will need to be flushed/re-wound). Where such a misspeculating thread writes to the RFC it may evict register values which are being used by another thread (a victim thread) in the processor, and consequently impacts the performance of the victim thread.

One way of reducing the impact of one thread on another simultaneously executing thread would be to allocate separate resources to each thread (e.g. to have a separate RFC for each thread). This means that a misspeculating thread only pollutes its own RFC. However, this leads to resource wastage when not all the threads are equally active (e.g. the RFC for an inactive thread will be under-utilized and the RFC for an active thread in the same processor core may be full).

Another way of reducing the impact of one thread on another thread would be to restrict the threads to write to specific ways of the RFC (where the cache is a set-associative or fully associative cache); however this limits the associativity which can be achieved and is not applicable for a directly mapped cache.

In the embodiments described below, the physical registers (in the RF) are allocated to threads based on which thread's instruction is writing to the physical register. This may be referred to herein as smart or intelligent register allocation. In the examples described herein, the physical registers are allocated based on an index (or ID or any other identifier) of a thread (i.e. where thread 0 has an index of 0, thread 1 has an index of 1, thread m has an index of m, etc); however it will be appreciated that equivalent mechanisms (e.g. which allocate an index in a different way or allocate registers in a different way whilst still being dependent upon which thread's instruction is writing to the register) may also be used to allocate physical registers to threads. The allocation mechanism (which may comprise a thread to group mapping or mapping criteria) may be strictly imposed or may be dynamically (at run-time) relaxed to operate on a preferential basis such that if one thread is more active than other threads in the same processor core (e.g. is issuing more instructions than other threads), the active thread may be allocated registers which would otherwise (i.e. if the allocation mechanism was fixed) be allocated to another, less active, thread. Use of a flexible allocation mechanism in this way ensures that the execution of active threads is not held up in spite of resources being available, and at the same time improves the efficiency of resource usage (and in particular the RFC, which may be directly mapped or set-associative).

The physical registers within a processor (or processor core) may be considered to be divided (logically rather than physically) into groups with different groups being used for different threads. The relationship between threads and groups may be referred to as the thread to group (thread-group) mapping (e.g. Thread A is allocated registers from Group A, Thread B is allocated registers from Groups B and C, etc). In some examples, the number of groups of registers may be the same as the number of threads within the processor core. For example, there may be two threads and two groups of registers, with the first thread, thread 0, being allocated registers from the first group and the second thread, thread 1, being allocated registers from the second group. In other examples, there may be more groups of registers than threads, e.g. 2 threads and 4 groups of registers. In such an example, a more active (or higher priority) thread may be allocated registers from more than one group and a less active thread may be allocated registers from a single group. In yet further examples, there may be more threads than groups of registers, e.g. 4 threads and 2 groups of registers, with the most active thread being allocated registers from one group and the other three threads being allocated registers from the other group.

The thread to group mapping may be defined by mapping criteria. The mapping criteria may explicitly identify groups of registers (e.g. group one comprises even registers and group two comprises odd registers) and the mapping between threads and these groups (e.g. thread 0 mapped to group one and thread 1 mapped to group two) or alternatively, the division of physical registers into groups may be implicit within the mapping criteria (e.g. an even thread is mapped to even registers and an odd thread is mapped to odd registers). These two ways of describing the mapping criteria are functionally equivalent and logically divide the registers into groups and allocate registers from a particular group based on the thread to which an instruction belongs.

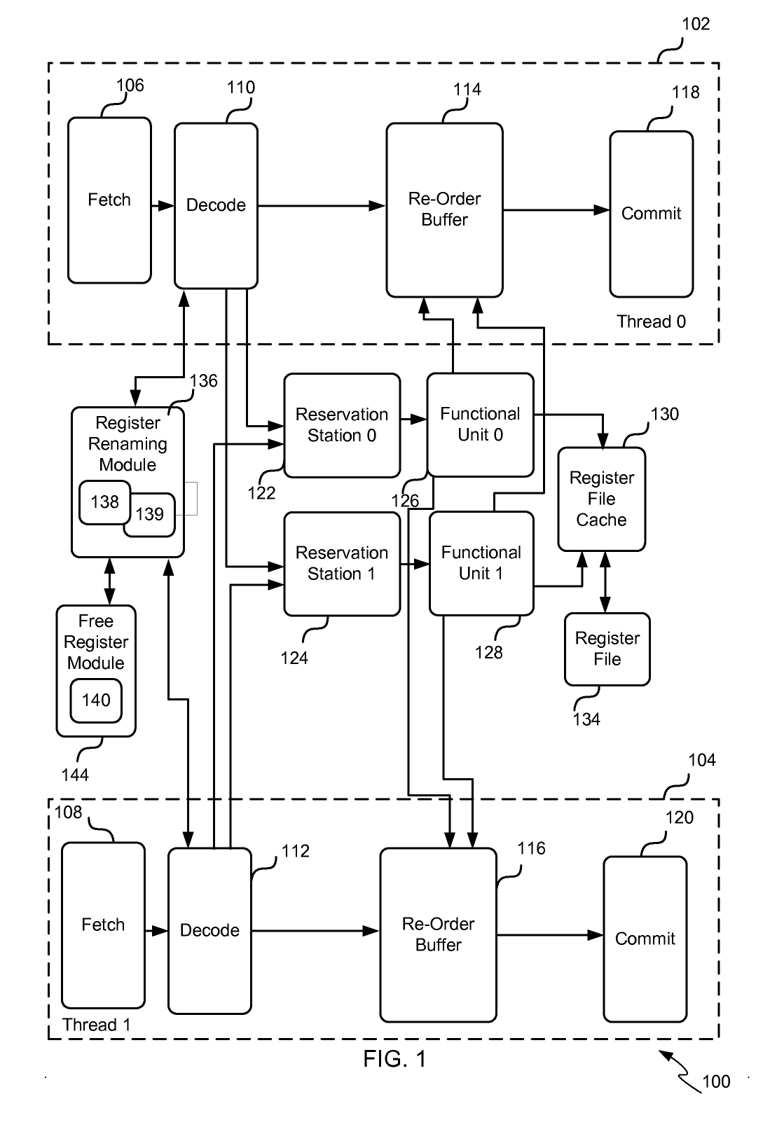

FIG. 1 is a schematic diagram of an example multi-threaded out-of-order processor 100. The processor 100 comprises two threads 102, 104 which are referred to herein as thread 0 and thread 1. Each thread 102, 104 comprises a fetch stage 106, 108, a decode stage 110, 112, a re-order buffer 114, 116 and a commit stage 118, 120. In the example shown, the threads 102, 104 share reservation stations 122, 124, functional units 126, 128, a register file cache (RFC) 130, a register file (RF) 134 and a register renaming module 136. The register renaming module 136 maintains a register renaming table 138, 139 for each thread. In some examples, there may be a separate RFC for each functional unit; however the methods described below are equally applicable irrespective of whether an RFC is shared between some/all functional units 126, 128 or there is one RFC for each functional unit. Each functional unit can operate on instructions belonging to any thread.

Each thread 102, 104 in the processor 100 comprises a fetch stage 106, 108 configured to fetch instructions from a program (in program order) as indicated by a program counter (PC). Once an instruction is fetched it is provided to a decode stage 110, 112.

The decode stage 110, 112 is arranged to interpret the instructions and interact with the register renaming module 136 which performs register renaming. In particular, each instruction may comprise a register write operation; one or more register read operations; and/or an arithmetic or logical operation. A register write operation writes to a destination register and a register read operation reads from a source register. During register renaming each architectural register referred to in an instruction (e.g. each source and destination register) is replaced (or renamed) with a physical register.

For register write operations the architectural register (e.g. destination register) referred to is allocated an unused (or available) physical register and the physical register allocated may be determined by the register renaming module 136. Any allocation may be stored in a register renaming table 138, 139 for the relevant thread, where the register renaming table 138, 139 is a data structure showing the mapping between each architectural register and the physical register allocated until that instruction in the program flow. It is this allocation process, performed in this example by the register renaming module 136, which allocates registers in a new way and is described in more detail below. For register read operations the correct physical register for a particular architectural register (e.g. source register) can be determined from an entry in the appropriate register renaming table 138 or 139 indexed by the architectural register.

After an instruction passes through the decode stage 110, 112 it is inserted into a reorder buffer 114, 116 (ROB) and dispatched to a reservation station 122, 124 for execution by a corresponding functional unit 126, 128. The reservation station 122, 124 that the instruction is dispatched to may be based on the type of instruction. For example, DSP instructions may be dispatched to the first reservation station 122 (reservation station 0) and all other instructions may be dispatched to the second reservation station 124 (reservation station 1).

The re-order buffer 114, 116 is a buffer that enables the instructions to be executed out-of-order, but committed in-order. The re-order buffer 114, 116 holds the instructions that are inserted into it in program order, but the instructions within the ROB 114, 116 can be executed out of sequence by the functional units 126, 128. In some examples, the re-order buffer 114, 116 can be formed as a circular buffer having a head pointing to the oldest instruction in the ROB 114, 116, and a tail pointing to the youngest instruction in the ROB 114, 116. Instructions are output from the re-order buffer 114, 116 to the commit stage 118, 120 in program order. In other words, an instruction is output from the head of the ROB 114, 116 when that instruction has been executed, and the head is incremented to the next instruction in the ROB 114, 116. Instructions output from the re-order buffer 114, 116 are provided to a commit stage 118, 120, which commits the results of the instructions to the register/memory.

Each reservation station 122, 124 receives instructions from the decode stage 110, 112 and stores them in a queue. An instruction waits in the queue until its input operand values are available. Once all of an instruction's operand values are available the instruction is said to be ready for execution and may be issued to a corresponding functional unit 126, 128 for execution. An instruction's operand values may be available before the operand values of earlier, older instructions allowing the instruction to leave the reservation station 122, 124 queue before those earlier, older instructions.

Each functional unit 126, 128 is responsible for executing instructions and may comprise one or more functional unit pipelines. The functional units 126, 128 may be configured to execute specific types of instructions. For example one or more functional units 126, 128 may be an integer unit, a floating point unit (FPU), a digital signal processing (DSP)/single instruction multiple data (SIMD) unit, or a multiply accumulate (MAC) unit. An integer unit performs integer instructions, an FPU executes floating point instructions, a DSP/SIMD unit has multiple processing elements that perform the same operation on multiple data points simultaneously, and a MAC unit computes the product of two numbers and adds that product to an accumulator. The functional units and the pipelines therein may have different lengths and/or complexities. For example, a FPU pipeline is typically longer than an integer execution pipeline because it is generally performing more complicated operations.

While executing the instructions received from the reservation station 122, 124, each functional unit 126, 128 performs reads and writes to physical registers in one or more shared register files 134. To reduce latency, recently written registers are stored in a register file cache 130 and in some examples there may be more than one RFC 130 (e.g. one per functional unit). In some cases register write operations performed on a register file cache 130 are immediately written to the register file 134. In other cases the register write operations are subsequently written to the register file 134 as resources become available.

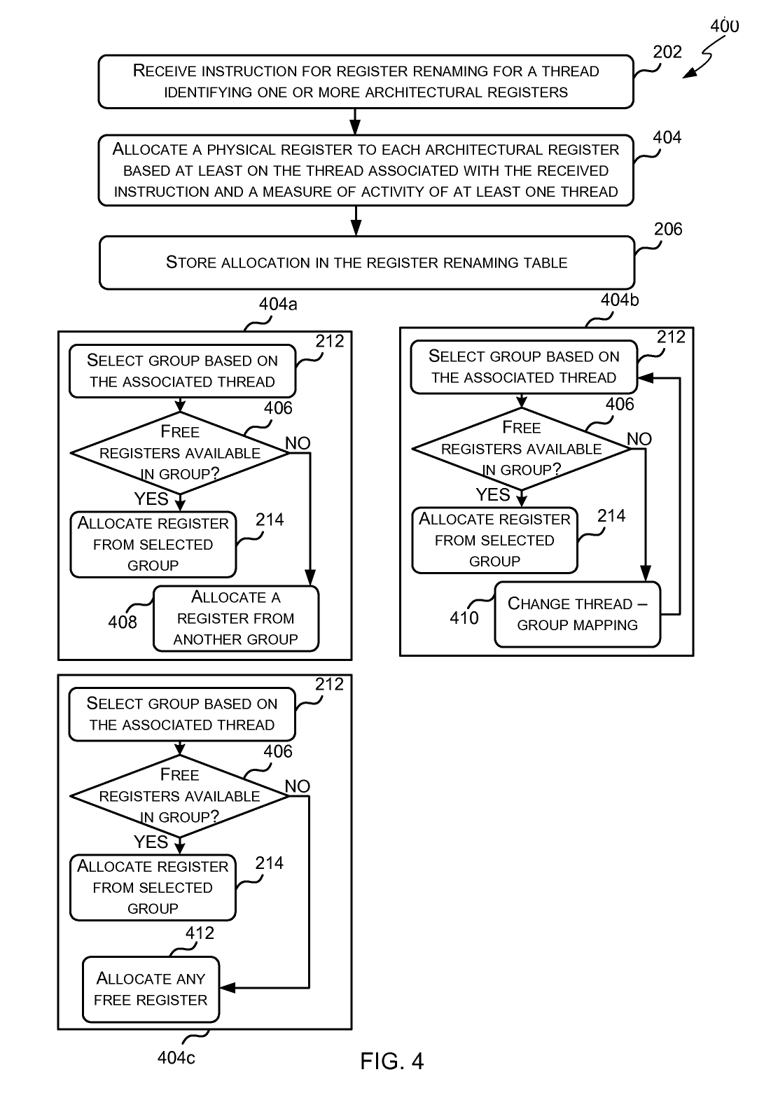

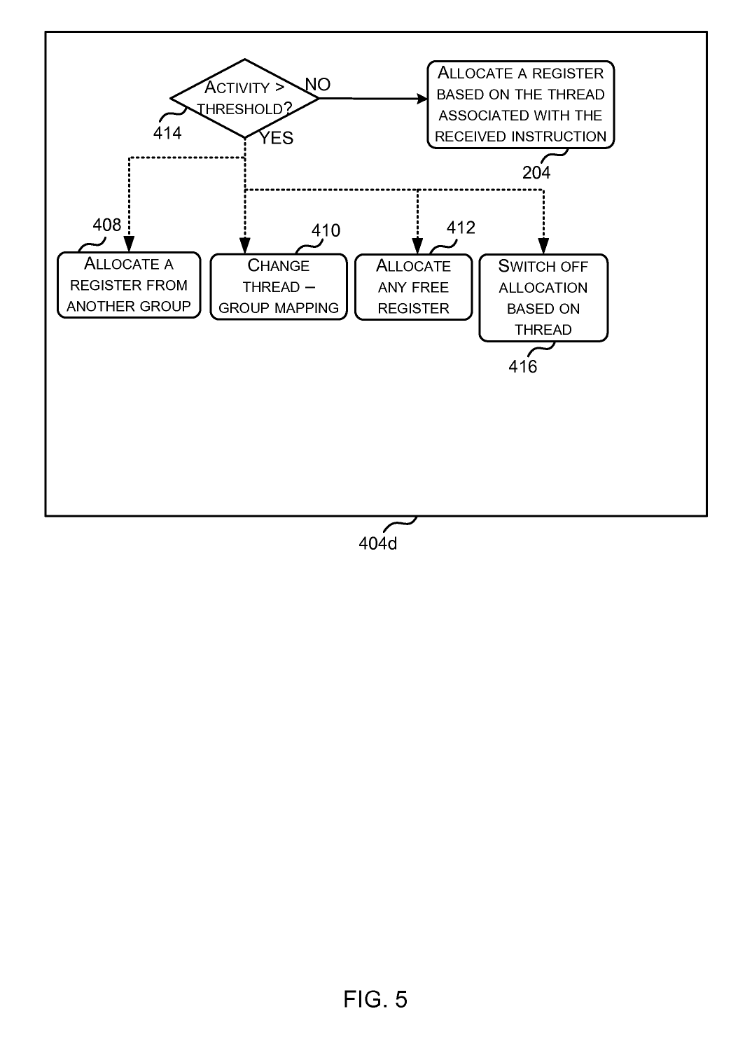

The position in the RFC to which a functional unit writes a register value is dependent upon the particular physical register which is being written. For example, if the RFC comprises 8 rows, a register value which is written by a functional unit to physical register 32 will be stored in the RFC in row (or index) 0, as 32 modulo 8=0 (which may also be written 32 mod 8=0), i.e. when 32 is divided by 8, the remainder is zero. In other examples, a modulo function may not be used and there may be an alternative scheme by which a position in an RFC is dictated by the particular physical register being written (e.g. based on most significant bit, such that registers 0-7 are stored in row 0, registers 8-15 are stored in row 1, etc). Consequently, by intelligently allocating physical registers to threads (in the register renaming module 136) as described herein, entries in the RFC for different threads can be kept separate from each other (except where the allocation method is relaxed, as described below with reference to FIGS. 4 and 5) and a misspeculating thread will then not affect the operation of other threads as it will not evict useful data in order to store data which subsequently proves to be useless.

If a register file cache 130 does not comprise an entry for a register specified in a register read operation then there is a register file cache miss. When a register file cache miss occurs the register read operation is performed on the register file 134, which increases the latency and may require the associated instruction and any other later issued related instructions to be removed or flushed from the functional unit pipelines(as described above).

The processor 100 may also comprise a branch predictor (not shown), which is configured to predict which direction the program flow will take in the case of instructions known to cause possible flow changes, such as branch instructions. As described above, branch prediction is useful as it enables instructions to be speculatively executed by the processor 100 before the outcome of the branch instruction is known.

When the branch predictor predicts the program flow accurately, this improves performance of the processor 100. However, if the branch predictor does not correctly predict the branch direction, then a misprediction occurs which needs to be corrected before the program can continue. To correct a misprediction, the speculative instructions sent to the ROB 114, 116 are abandoned, and the fetch stage 106, 108 starts fetching instructions from the correct program branch.

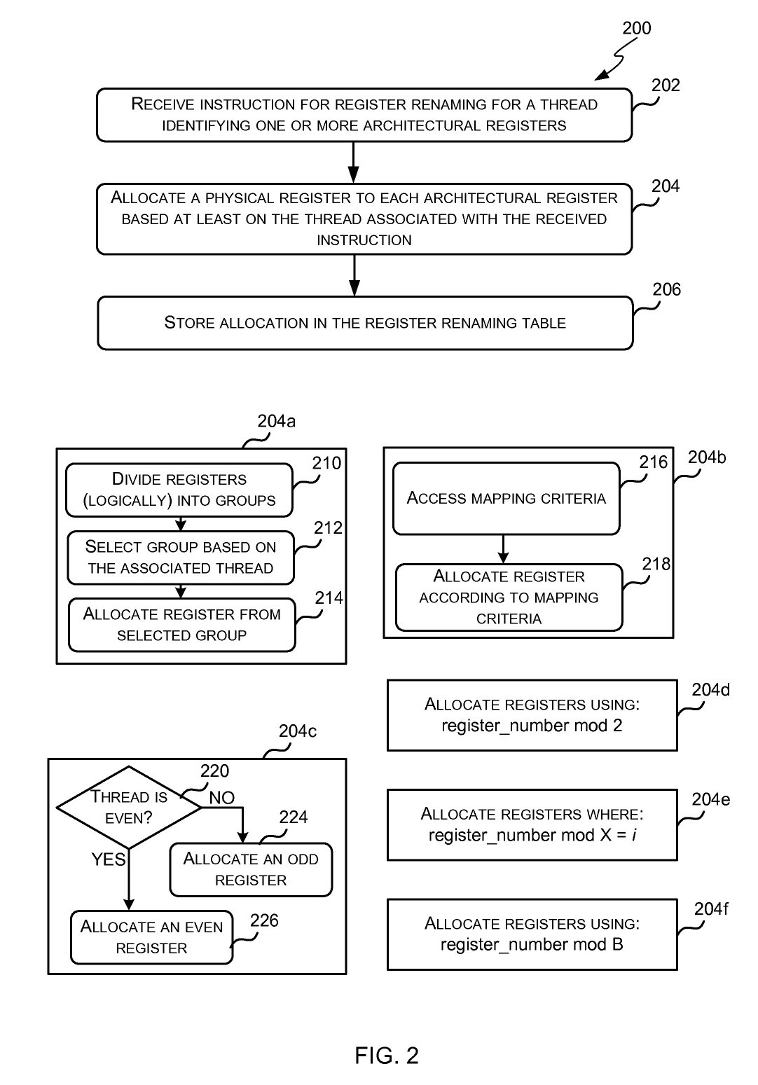

FIG. 2 shows a flow diagram 200 of an example method of physical register allocation (or register renaming) which may be performed by the register renaming module 136 shown in FIG. 1. It will be appreciated that although FIG. 1 shows a processor comprising two threads 102, 104 the methods described herein are applicable to any multi-threaded out-of-order processor (with two or more threads).

The physical register allocation is triggered when an instruction for register renaming is received (block 202). The instruction (received in block 202) is received from the decode stage 110, 112 for the associated thread and identifies both a thread associated with the instruction (i.e. the thread which fetched the particular instruction) and one or more architectural registers which are to be allocated physical registers in the register renaming operation (i.e. destination registers of the instruction). The associated thread may be identified implicitly (e.g. on the basis of which decode stage 110, 112 the instruction was received from) or the associated thread may be identified explicitly within the sideband data passed with the received instruction from the previous stage.

A physical register is then allocated to each identified architectural destination register based on the thread associated with the instruction (block 204), e.g. based on mapping criteria, and this allocation is recorded in the register renaming table (block 206). The allocation may be based on other factors in addition to the associated thread (e.g. based on the activity of threads, as described in more detail below with reference to FIGS. 4 and 5) and these other factors may be included within the mapping criteria or result in use of different mapping criteria in different situations.

FIG. 2 also shows two example implementations for the allocation operation in block 204, denoted 204a-204b. In the first example 204a, the physical registers within the register file 134 are logically divided into groups (block 210) and a group of registers is selected based on the associated thread (block 212), e.g. using the mapping criteria. An available (or free) physical register from the selected group of registers is then allocated to each architectural destination register (block 214), i.e. a different physical register from the selected group is allocated to each architectural destination register of each instruction received in block 202.

The registers are described herein as being logically divided into groups because they are not physically divided into groups and registers within a group may not be sequential and the grouping of registers may change over time.

It will be appreciated that the logical division of registers into groups may be fixed and so block 210 (in example 204a) may not be performed each time and/or may be performed prior to the physical register allocation (e.g. prior to method 200).

In the second example 204b, mapping criteria are accessed (block 216) and then a physical register is allocated to each destination architectural register identified in the instruction received in block 202 based on the mapping criteria (block 218). In this example, the mapping criteria includes at least the thread associated with the instruction and as described above, the logical division of registers into groups may be absorbed into the mapping criteria (i.e. such that the mapping criteria effectively divides the registers into logical groups) and/or the mapping criteria may explicitly specify a particular group of physical registers. As a result, examples 204a and 204b, although expressed differently, are functionally equivalent.

FIG. 2 additionally shows four examples of mapping criteria as accessed in block 216 and used in block 218, denoted 204c-204f. Example 204c shows an example for a processor comprising two threads (e.g. as shown in FIG. 1) and these threads may be denoted thread 0 and thread 1. In this example, the mapping criteria is based on whether a thread is odd or even and if the associated thread is even (‘Yes’ in block 220), i.e. for thread 0, even registers are allocated to each architectural destination register identified in the instruction received in block 202 (block 222). If, however, the associated thread is odd (‘No’ in block 222), i.e. for thread 1, odd registers are allocated to each architectural destination register identified in the instruction received in block 202 (block 224). As described above, this mapping criteria logically divides the registers into two groups on the basis of the number of the register: odd registers and even registers.

Where there are only two threads, example 204c isolates the effects of cache evictions for one thread from the other thread. Example 204c may also be applied to processors comprising more than two threads; however, in this case, there is not total isolation, but instead the effects of cache evictions for one thread impact only half the threads (e.g. where a write instruction for an even thread results in an RFC entry being evicted to enable a new value to be stored, the entry which is evicted will belong to an even thread and there will be no impact on odd threads).

The mapping criteria in example 204c, may be equivalent to the mapping criteria shown in example 204d. In example 204d, a register is allocated according to the value of:
register_number mod 2
   where register_number is the number of the register. In other words, the physical registers are divided logically into groups according to the value of register_number mod 2. To make this example 204d equivalent to the previous example 204c, a register may be allocated to a thread i if:
register_number mod 2=i

This mapping criteria may be considered to define a thread to group mapping, with thread i being mapped to a group of registers comprising those registers satisfying register_number mod 2=i.

As with example 204c, example 204d may also be applied to processors comprising more than two threads. For example, with four threads (thread 0, 1, 2, 3) the even threads (threads 0 and 2) may be allocated registers where register_number mod 2=0 and the odd threads (threads 1 and 3) may be allocated registers where register_number mod 2=1. In such an example, the mapping criteria may be considered to define a thread to group mapping as follows:
Thread 0 mapped to a group comprising registers satisfying register_number mod 2=0
Thread 1 mapped to a group comprising registers satisfying register_number mod 2=1
Tread 2 mapped to a group comprising registers satisfying register_number mod 2=0
Thread 3 mapped to a group comprising registers satisfying register_number mod 2=1

Although in the examples described herein even threads are described as being allocated even registers, etc, it will be appreciated that in other examples even threads may be allocated odd registers and vice versa, as follows:
Thread 0 mapped to a group comprising registers satisfying register_number mod 2=1
Thread 1 mapped to a group comprising registers satisfying register_number mod 2=0

Example 204e is a generalisation of example 204d. In example 204e, the registers may be considered to be logically divided into X groups, where the processor comprises X threads and a register may be allocated to a thread i if:
register_number mod X=i

The final example 204f is a further generalisation of the previous examples 204c-204ein which the registers may be logically divided into B groups, where the processor comprises X threads and a register may be allocated to a thread according to a value of:
register_number mod B

A logical group therefore comprises those registers which satisfy the following criteria:
register_number mod B=b
   with different groups having different values of b, where b=0, 1, . . . B-1. A thread may be allocated registers from one or more groups and in some examples, multiple threads may be allocated registers from the same group. This mapping of threads to groups may be fixed or dynamically set during runtime.

If B=X, example 204f is equivalent to example 204e, and if B=X=2, example 204f is equivalent to both example 204c and example 204d. More generally however, B does not have to be equal to X (i.e. there may be a different number of logical groups compared to the number of threads in the processor) and the relationship between threads and groups of registers may be defined in any way and various examples are described below. As described above, the mapping between threads and groups may be fixed or may change (e.g. may be dynamically adapted, for example, based on thread activity or availability of physical registers).

If B>X (i.e. there are more groups than threads), each thread may be allocated registers from one or more groups (with different threads being allocated registers from different groups) and the number of groups allocated to a thread may depend on the activity of the particular thread. For example, where B=X+1, each thread may be allocated registers from a different one of the B groups with the exception of the most active thread which may be allocated registers from two of the B groups (where these two groups are not used for any of the other threads). In another example, B=αX where a is an integer and each thread may be mapped to one or more of the B groups (e.g. depending upon the activity of a thread). Where the thread to group mapping is dependent upon activity, this mapping may change dynamically.

There may be an upper limit on the size of B because as B increases, the total number of physical registers in each group reduces. Where the allocation method described above is strictly enforced, the size of B is limited (unless deadlocks are to be allowed to occur) by a requirement that the total number of physical registers available for any thread is at least one greater than the total number of architectural registers. This at least one additional physical register ensures that the free list of registers is not empty, even when a physical register is allocated to each architectural register of every thread. Without at least one additional physical register, a new instruction could not be executed as renaming cannot occur.

If B<X (i.e. there are fewer groups than threads), two or more of the less active (and/or less speculative) threads may be allocated registers from the same group. A more active and/or more speculative thread may be allocated registers from a dedicated group of registers (i.e. which is not used to allocate registers to other threads) in order to isolate the impact of the more active and/or more speculative thread from the other threads. For example, where B=2 and X>2, the most active (and/or most speculative) thread may be allocated registers from one group and the other threads may be allocated registers from the other group. In another example, where B=X−1, the two least active threads may be allocated registers from the same group, with each other thread (of the X threads) being mapped to a dedicated group of registers (which are only allocated to that thread and not to other threads).

It will be appreciated that the examples shown in 204a-204f show just some ways in which physical registers may be allocated (in block 204) to each architectural register based on the thread associated with the write instruction and variations or alternative methods may be used. For example, any combination of the methods described above may be used.

As described above, the physical register which is allocated (in block 204) then determines the location in which a recently written value is stored within the RFC 130. The allocation of a location within the RFC is based on the register number of the physical register and may use the formula described above or any other method.

In some examples, a free register list 140 may be used to track which physical registers from each of the logical groups of registers are available for allocation and may comprise a plurality of sub-lists 142, one for each group of registers. Each sub-list may list the unallocated (i.e. free) registers in the group of registers and this may be used by the register renaming module 136 when allocating physical registers (e.g. in block 204). In an example, the register renaming module 136 may request a free register from a particular group from the free register list 140 or may access the list to identify a free register from a particular group. The updating of the free register list 140 may be performed by the free register module 144.

The free register list 140, free register module 144 or the register renaming module 136 may also record the number of registers allocated from each group (or sub-list) within a window (which may be defined in terms of a period of time or a number of register allocations) and this information may be used to relax or otherwise control use of the register allocation method shown in FIG. 2.

Where a free register list 140 is used, it will be appreciated that the allocation mechanism described above may be implemented by either the register renaming module 136 (as described above) or by the free register module 144. Where the allocation mechanism (e.g. as shown in FIG. 2) is implemented by the free register module 144, the register renaming module 136 requests a free register for a particular thread from the free register module 144 (e.g. in block 202) and the free register module 144 performs the register allocation (block 204) and returns details of a free register back to the register renaming module 136, in order that the register renaming module 136 can then store the allocation in the register renaming table 138, 139 (in block 206).

It will further be appreciated that the operation of the register renaming module 136 and free register module 144 may be combined into a single module or alternatively, there may be a different split in functionality between the two modules.

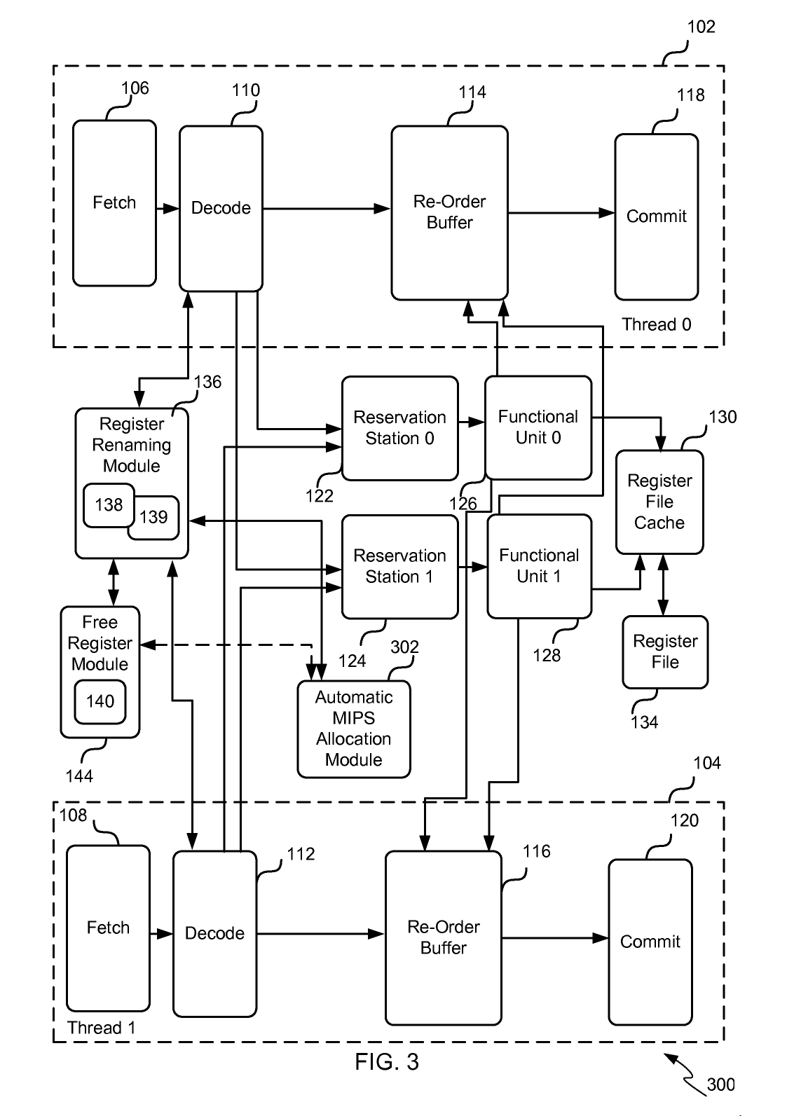

FIG. 3 is a schematic diagram of a further example multi-threaded out-of-order processor 300. The processor 300 comprises an Automatic MIPS Allocation (AMA™) module 302. The AMA™ module 302 monitors the activity of each of the threads in the processor 300 and provides a control signal to the register renaming module 136 (or the free register module 144, if this performs the allocation method) to influence the way that physical registers are allocated to different threads. This control signal may influence the allocation of physical registers in one or more different ways, such as:
by relaxing the allocation policy such that an active thread may be allocated registers from groups of registers that would otherwise be used only by other threads;
by changing the relationship between threads and groups within the allocation policy (e.g. such that a thread is allocated an additional group or a different group of registers, or such that the resources allocated to a thread which is being executed speculatively can be isolated from other threads);
by turning off the allocation policy for a subset of the threads (i.e. one or more threads but not all the threads); and
by turning off the allocation policy completely (i.e. for all threads in the processor).

There are many different ways in which the AMA™ module 302 may monitor the activity of each of the threads and the activity may be defined in a number of different ways such as the number of instructions issued and/or how speculatively the thread is being executed. In one example, the AMA™ module 302 tracks the allocation of registers to individual threads over a given window (e.g. defined in time or number of allocations). This allocation information may be stored in the free register list 140, the free register module 144, the register renaming module 136 or the AMA™ module 302. A thread which has issued more instructions (for different architectural registers) and hence had more physical registers allocated to it within the window may be considered more active than a thread that has had fewer physical registers allocated to it within the same window. In another example, the AMA™ module 302 determines which threads are being executed speculatively. As described above, although FIG. 3 shows two threads, the methods described herein are applicable to any multi-threaded out-of-order processor (with two or more threads).

FIG. 4 shows a flow diagram 400 of another example method of physical register allocation (or register renaming) and in which the allocation of registers is influenced by a measure of activity of at least one thread in the processor (block 404). This measure of activity (used in block 404) may be a control signal generated by the AMA™ module 302 or other element. Alternatively, this measure of activity may be based on an input from the free register list 140 or free register module 144 (e.g. which identifies that one of the sub-lists is empty or nearly empty) or may be defined in any other way and by any other element within the processor.

FIG. 4 also shows a number of example implementations for the allocation operation which is influenced by a measure of activity (block 404), denoted 404a-404c. A fourth example implementation, 404d, is shown in FIG. 5. The first two examples 404a, 404b show two different implementations in which the allocation policy (as shown in FIG. 2) is relaxed when there are no available physical registers from the selected group (‘No’ in block 406), where this selected group is selected (in block 212) based on the thread associated with the received instruction (as described above). In the first example, 404a, if there is no available physical register from the selected group (‘No’ in block 406), an available register is allocated from another group (block 408), for example from a group which is otherwise allocated to the least active thread.

In the second example, 404b, if there are no available physical registers from the selected group (‘No’ in block 406), the thread to group mapping (which is used to select a group for a thread) is modified (block 410) before a new group is selected (in block 212) and an available register then allocated from the new selected group (in block 214). As the thread to group mapping is modified in this example, the allocation of registers for other threads may also be affected, unlike in example 404a which is a one off operation which applies only to a particular register allocation operation.

In the third example, 404c, the allocation policy is switched off for the thread where there are no available physical registers from the selected group (‘No’ in block 406) and consequently any free physical register is allocated (block 412). Like example 404a, example 404c only affects register renaming for the particular thread and not the other threads, although the operation of other threads may be impacted if the register allocation (in block 412) causes data required by another thread to be evicted from the RFC.

It will be appreciated that although examples 404a-404c show the modification to the allocation policy being implemented when there are no available physical registers from the selected group (‘No’ in block 406), in other examples, the modification may be implemented at an earlier stage, e.g. when the number of available registers from the selected group falls below a threshold, or in response to a control signal (e.g. from the AMA™ module 302).

The fourth example, 404d (in FIG. 5), shows the modification of the allocation policy (in a number of different ways) when the activity of a thread (or a collection of threads) exceeds a threshold activity level. The activity level may be defined in any way (e.g. the number of registers allocated from a group within a window) and the threshold may also be defined in any way. As described above, the determination that the activity level exceeds the threshold may be made in response to a control signal received from an element external to the register renaming module 136 or by the register renaming module itself.

In this example, when the activity (of one or more threads) exceeds a threshold (‘Yes’ in block 414), a number of different things may occur, as indicated by the dotted arrows in FIG. 5. In a first example, a register may be allocated from another group (block 408) in a similar manner to example 404a. In a second example, the thread to group mapping (or mapping criteria) may be changed (block 410) and a group is then selected based on this new mapping and a register is allocated from the selected group (in a similar manner to example 404b). In a third example, any available physical register may be allocated (block 412) in a similar manner to example 404c and in the fourth example the allocation policy may be switched off for all threads for a period of time or until the activity falls below the threshold (block 416). At the end of the period of time, or when the activity falls below the threshold, the allocation policy may be switched on again for all threads.

The methods shown in FIGS. 4 and 5 and described above provide flexibility in situations where a thread is very active and would otherwise be constrained by the soft-partitioning of the RFC through smart allocation of physical registers as shown in FIG. 2. Using the methods described with reference to FIGS. 4 and 5, the allocation of registers may be controlled such that the RFC utilization is 100% even as the load of an individual thread varies over time.

Although the description of FIG. 4 refers exclusively to use of groups, as described above (with respect to FIG. 2), these groups may be defined in terms of mapping criteria and the mapping criteria may be used to allocate registers in any of the methods shown in FIG. 4.

Where the smart allocation of physical registers is based on the ‘register_number mod B=b’ policy or any of its subsets (E.g. FIG. 204c-e), the free register list may employ simple hardware logic to determine the eligible physical registers that satisfy the allocation policy. Amongst the pool of available (unused) registers, the hardware logic may inspect the ‘log₂(B)’ least significant bits of the available physical register number to match it to ‘b’, as the required condition to allocate that physical register. This hardware implementation technique is explained below with concrete examples.

Where registers are logically divided into groups based on modulo 2 (i.e. odd/even) it is only necessary to inspect the least significant bit (LSB) of the register number (LSB=0, then register is even, LSB=1, then register is odd). Similarly, where the mapping criteria (or register grouping) is based on modulo 4, it is only necessary to inspect the two least significant bits and where the mapping criteria (or register grouping) is based on modulo 8, it is only necessary to inspect the three least significant bits of the register number.

The methods described herein comprise smart allocation of physical registers to architectural registers based on the thread associated with a given instruction and this subsequently affects where the data gets stored in the RFC. The register renaming therefore allocates not only physical registers but also, dynamically allocates resources (e.g. the RFC) in addition to physical registers.

The smart allocation described herein isolates the impact of individual threads within a processor core from each other and this is particularly useful where threads are executed aggressively using speculation techniques.

By applying a degree of flexibility in how the smart allocation policy is imposed (e.g. as shown in FIGS. 4 and 5), the utilization of the RFC can be optimized.

Although the methods above are described with reference to allocation of the RFC (in addition to physical registers), the methods may also be used to dynamically allocate resources within the Re-order Buffer and/or Reservation Station storage.

The methods described herein may be used in any multi-threaded out-of-order processor, irrespective of the number of threads (two or more) and/or the number of processor cores.

The term ‘processor’ and ‘computer’ are used herein to refer to any device, or portion thereof, with processing capability such that it can execute instructions. Those skilled in the art will realize that such processing capabilities are incorporated into many different devices and therefore the term ‘computer’ includes set top boxes, media players, digital radios, PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

A particular reference to “logic” refers to structure that performs a function or functions. An example of logic includes circuitry that is arranged to perform those function(s). For example, such circuitry may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnect, by way of example. Such elements may be provided as custom circuits or standard cell libraries, macros, or at other levels of abstraction. Such elements may be interconnected in a specific arrangement. Logic may include circuitry that is fixed function and circuitry can be programmed to perform a function or functions; such programming may be provided from a firmware or software update or control mechanism. Logic identified to perform one function may also include logic that implements a constituent function or sub-process. In an example, hardware logic has circuitry that implements a fixed function operation, or operations, state machine or process.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A computer-implemented method of using register renaming to dynamically allocate a resource, in addition to physical registers, between threads in a multi-threaded out-of-order processor, the method comprising, in a processing module:
receiving an instruction for register renaming, the instruction identifying an architectural register and a thread associated with the instruction;
allocating an available physical register from a plurality of physical registers in the multi-threaded processor to the architectural register based at least on the thread associated with the instruction, wherein each of the plurality of physical registers is mapped to one or more storage locations in the dynamically allocated resource; and
storing details of the register allocation.

2. A method according to claim 1, wherein the dynamically allocated resource is a register file cache in the multi-threaded out-of-order processor.

3. A method according to claim 1, wherein the dynamically allocated resource is one of a re-order buffer and reservation station storage in the multi-threaded out-of-order processor.

4. A method according to claim 1, wherein the plurality of physical registers are divided logically into groups and allocating an available physical register from the plurality of physical registers to the architectural register based at least on the thread associated with the instruction comprises:
selecting a group based at least on the thread associated with the instruction; and
allocating an available physical register from the selected group to the architectural register.

5. A method according to claim 1, wherein allocating an available physical register from the plurality of physical registers to the architectural register based at least on the thread associated with the instruction comprises:
allocating an available physical register from the plurality of physical registers to the architectural register using predefined mapping criteria.

6. A method according to claim 5, wherein each physical register is identified by a number, register_number, and the predefined mapping criteria is register_number modulo B, where B is an integer.

7. A method according to claim 6, wherein B=X and X is the number of threads in the multi-threaded out-of-order processor and wherein allocating an available physical register from the plurality of physical registers to the architectural register using predefined mapping criteria comprises:
allocating an available physical register based on register_number modulo X.

8. A method according to claim 7, wherein each thread in the multi-threaded out-of-order processor has an identifier i, allocating an available physical register based on register_number modulo X comprises:
allocating an available physical register which satisfies register_number modulo X=i.

9. A method according to claim 1, wherein an available physical register from the plurality of physical registers is allocated to the architectural register based at least on the thread associated with the instruction and a measure of activity of at least one thread in the multi-threaded out-of-order processor.

10. A method according to claim 9, wherein the plurality of physical registers are divided logically into groups and allocating an available physical register from the plurality of physical registers to the architectural register based at least on the thread associated with the instruction and a measure of activity of at least one thread in the multi-threaded out-of-order processor comprises:
selecting a group based at least on the thread associated with the instruction;
allocating an available physical register from the selected group to the architectural register; and
if there are no available physical registers in the selected group, allocating an available register from another group.

11. A method according to claim 9, wherein the plurality of physical registers are divided logically into groups and allocating an available physical register from the plurality of physical registers to the architectural register based at least on the thread associated with the instruction and a measure of activity of at least one thread in the multi-threaded out-of-order processor comprises:
selecting a group based at least on the thread associated with the instruction;
allocating an available physical register from the selected group to the architectural register; and
if there are no available physical registers in the selected group, changing a mapping between threads and groups, selecting a group based at least on the thread associated with the instruction and the changed mapping; and allocating an available physical register from the newly selected group to the architectural register.

12. A method according to claim 9, wherein allocating an available physical register from the plurality of physical registers to the architectural register based at least on the thread associated with the instruction and a measure of activity of at least one thread in the multi-threaded out-of-order processor comprises:
if an activity level of the thread associated with the instruction does not exceed a threshold, allocating an available physical register from the plurality of physical registers to the architectural register based on the thread associated with the instruction; and
if an activity level of the thread associated with the instruction exceeds a threshold, allocating any available physical register to the architectural register.

13. A method according to claim 9, wherein the plurality of physical registers are divided logically into groups and allocating an available physical register from the plurality of physical registers to the architectural register based at least on the thread associated with the instruction and a measure of activity of at least one thread in the multi-threaded out-of-order processor comprises:
if an activity level of the thread associated with the instruction does not exceed a threshold, allocating an available physical register from the plurality of physical registers to the architectural register based on the thread associated with the instruction and a thread to group mapping; and
if an activity level of the thread associated with the instruction exceeds a threshold, changing the thread to group mapping and then allocating an available physical register from the plurality of physical registers to the architectural register based on the thread associated with the instruction and a thread to group mapping.

14. A method according to claim 9, wherein allocating an available physical register from the plurality of physical registers to the architectural register based at least on the thread associated with the instruction and a measure of activity of at least one thread in the multi-threaded out-of-order processor comprises:
if an activity level of the at least one thread does not exceed a threshold, allocating an available physical register from the plurality of physical registers to the architectural register based on the thread associated with the instruction; and
if an activity level of the at least one thread exceeds a threshold, allocating any available physical register to the architectural register.

15. A method according to claim 9, wherein allocating an available physical register from the plurality of physical registers to the architectural register based at least on the thread associated with the instruction and a measure of activity of at least one thread in the multi-threaded out-of-order processor comprises:
if an activity level of the at least one thread does not exceed a threshold, allocating an available physical register from the plurality of physical registers to the architectural register using mapping criteria; and
if an activity level of the at least one thread does exceed a threshold, modifying the mapping criteria prior to allocating an available physical register from the plurality of physical registers to the architectural register using the modified mapping criteria.

16. A method according to claim 15, wherein the at least one thread comprises the thread associated with the instruction.

17. A method according to claim 9, wherein the plurality of physical registers are divided logically into groups and the measure of activity of at least one thread is determined based on a number of registers allocated from a group in a predefined window.

18. A method according to claim 9, wherein the measure of activity of at least one thread is determined based on a signal received from an Automatic MIPS Allocation module.

19. A module in a multi-threaded out-of-order processor arranged to use register renaming to dynamically allocate a resource, in addition to physical registers, between threads in the processor, the module comprising hardware logic arranged to:
allocate an available physical register from a plurality of physical registers in the processor to an architectural register in an instruction based at least on a thread associated with the instruction, wherein each of the plurality of physical registers is mapped to one or more storage locations in the dynamically allocated resource.

20. A non-transitory computer readable storage medium having encoded thereon computer readable program code for generating a processor configured to:
receive an instruction for register renaming, the instruction identifying an architectural register and a thread associated with the instruction;
allocate an available physical register from a plurality of physical registers in the processor to the architectural register based at least on the thread associated with the instruction, wherein each of the plurality of physical registers is mapped to one or more storage locations in the dynamically allocated resource; and
store details of the register allocation.
